(19) United States
(12) Patent Application Publication
(10) Pub. No.: US 2024/0164357 A1
(43) Pub. Date: May 23, 2024

(54) DYING BAIT FISH LURE

(71) Applicant: James Edwards Milton, Malaga, NJ (US)

(72) Inventor: James Edwards Milton, Malaga, NJ (US)

(21) Appl. No.: 18/506,231

(22) Filed: Nov. 10, 2023

Related U.S. Application Data
(60) Provisional application No. 63/427,463, filed on Nov. 23, 2022.

(51) Int. Cl. A01K 85/00

(52) U.S. Cl. CPC A01K 85/1837

(57) ABSTRACT

A dying bait fish lure includes a lure member resembling a bait fish with a head, a body, and a tail; a lip member; a weight member; and one or more hook elements. An eyelet, disposed on a front nose end of the lure member, connects to a fishing line. The lip member is disposed dorsally behind and above the head of the lure member. The lip member provides direction to the dying bait fish lure and facilitates a dying bait fish action including a straight, upward swim action during retrieval of the fishing line followed by a motionless, slow, downward fall action when the retrieval of the fishing line is paused. The weight member, disposed at a location between a center of the body and the head of the lure member, maintains an upright balance and executes the motionless, slow, downward fall action of the dying bait fish lure.

### CROSS-REFERENCE TO RELATED APPLICATIONS

This application claims priority to and the benefit of the provisional patent application titled “Dying Minnow Bait Lure”, application No. 63/427,463, filed in the United States Patent and Trademark Office on Nov. 23, 2022. The specification of the above-referenced patent application is incorporated herein by reference in its entirety.

### BACKGROUND

Fishing, also referred to as angling, is a sport of catching fish, typically using a fishing rod, a fishing reel, a fishing line, a hook, and a bait or a fishing lure. A fishing lure is a small artificial fishing bait that is designed to resemble fish prey, for example, flies, insects, worms, freshwater crustaceans such as crayfish, bait fish such as a minnow, etc., for attracting and luring predatory fish. The fishing lure is tied to an end of the fishing line and pulled through water, for example, in a retrieve mode, by an angler. As used herein, “retrieve mode” refers to a mode of reeling in a fishing line with a bait or a fishing lure from the water using the fishing rod and the fishing reel during fishing. There are different types of fishing lures, for example, jigs, spinners, spinner baits, spoon baits, swimbaits, fly lures, crankbaits, etc., which use a combination of movements, vibrations, colors, lustrous reflections, elements such as bristles, hair, beads, skirts, wire frames, etc., to entice the predatory fish to strike the fishing lure.

Different fishing lures are designed to attract fish in different ways based on their size, shape, sound, color, and movement. For example, a fishing lure may be colored and sized to resemble a minnow. Many anglers use fishing lures that simulate the action of live bait, for example, a swimming minnow. Typically, an angler pulls such fishing lures through the water at a relatively high speed in order to simulate the movement of live bait. Most fishing lures simulate a forward and downward movement. For example, a conventional swimming minnow lure includes a lip that is attached below the head of the lure, which causes the lure to swim and dive in a downward direction when retrieved. It has been observed that some predatory fish are strongly attracted to weak, injured, or dying minnow that move with erratic actions. These predatory fish are, therefore, more responsive, or may be induced to strike when otherwise not inclined, by the erratic movements of an injured or dying minnow, rather than by the movements of a healthy, swimming minnow. The action of an injured or dying minnow as it moves through water includes swimming in a straight, upward direction followed by falling in a downward direction, head first. In nature, an injured or dying minnow darts through the water, swims in an upward direction, and then falls slowly in a motionless, downward direction repeatedly until the minnow dies. This dying minnow action invokes and causes a predatory and instinctive reaction from a predatory fish. The predatory fish observing the upward movement and downward fall of the injured or dying minnow recognizes these erratic actions as that of easy prey and attacks the injured or dying minnow. This instinctive, irresistible, reaction or response causes even a non-feeding fish to strike the injured or dying minnow.

The upward movement and downward fall disclosed above is sometimes referred to as jigging. A fishing lure used in jigging, herein referred to as a jig, performs a generally unnatural upward then downward movement. A jig is a lead-headed hook with hair, plastic, or bait attached thereto. The jig does not perform a swimming action during an upward pull of the fishing line and comes up at an angle of the fishing line, not necessarily in a straight, upward direction. When the fishing line is released or relaxed, which reduces the tension of the fishing line, the jig tends to fall substantially unnaturally fast due to its weighted design, thereby reducing the chances of luring or invoking a response to strike from a predatory fish.

Hence, there is a long-felt need for a fishing lure that simulates the action of an injured or dying bait fish, for example, an injured or dying minnow, which comprises a natural, straight, upward swim action when the fishing lure is pulled through water during retrieval of a fishing line, followed by a natural, dead, motionless, slow, downward fall action when the retrieval of the fishing line is paused, for enhancing the chances of attracting and catching target game fish.

### SUMMARY OF THE INVENTION

This summary is provided to introduce a selection of concepts in a simplified form that are further disclosed in the detailed description of the invention. This summary is not intended to determine the scope of the claimed subject matter.

The fishing lure disclosed herein addresses the above-recited need for a dying bait fish lure that simulates an action of an injured or dying bait fish, for example, an injured or dying minnow, which comprises a natural, straight, upward swim action when the fishing lure is pulled through water during retrieval of a fishing line, followed by a natural, dead, motionless, slow, downward fall action when the retrieval of the fishing line is paused, for enhancing the chances of attracting and catching target game fish. The dying bait fish lure disclosed herein comprises a lure member, a lip member, a weight member, one or more hook elements, and an eyelet. The lure member is configured to resemble a bait fish, for example, a minnow, comprising a head, a body, and a tail. The head, the body, and the tail define an interior cavity within the lure member. The lure member is made, for example, from hard or soft plastic with neutral buoyancy or from malleable materials, to present a lifelike appearance. The lip member is disposed dorsally behind and above the head of the lure member. The lip member is configured in one of various shapes. In an embodiment, the lip member is attached above the head of the lure member using fasteners. In another embodiment, the lip member is molded as part of the lure member. The lip member is configured to provide direction to the dying bait fish lure and facilitate a dying bait fish action, for example, a dying minnow action, comprising a straight, upward swim action during retrieval of the fishing line followed by a motionless, slow, downward fall action when the retrieval of the fishing line is paused. In an embodiment, the lip member is a curved, generally ovular-shaped member configured in one of multiple variable sizes for facilitating multiple actions and upward movements of the dying bait fish lure.

The weight member of the dying bait fish lure is disposed in the interior cavity of the lure member, at a location between a center of the body and the head of the lure member. A horizontal interception of the location of the weight member is along a lower center line of a belly of the lure member, with a center of the weight member disposed slightly forward of a central balance point of the lure member, toward the head of the lure member, to cause a head-first dive of the dying bait fish lure in water when tension in the fishing line is reduced. The weight member is configured to maintain the belly of the lure member in a downward position while keeping the lip member facing in an upward direction for a straight, upward swim action of the dying bait fish lure during retrieval of the fishing line. The weight member is located within the interior cavity of the lure member, at the bottom belly of the lure member, aiding its balance to maintain the belly of the lure member in a downward position. The weight member is disposed slightly forward of the central balance point along the belly of the lure member, thereby facilitating both upward swimming and downward falling actions of the dying bait fish lure. The weight member is configured to have one of various shapes and is attached within the interior cavity of the lure member using different attachment methods. In an embodiment, the weight member is a generally rectangular-shaped member with an extended length for weight distribution within the lure member. In another embodiment, the weight member is a generally ovular-shaped member with an extended length for weight distribution within the lure member.

The weight member is configured to maintain an upright balance and execute the motionless, slow, downward fall action of the dying bait fish lure by the weight distribution of the weight member being disposed slightly forward of the central balance point of the lure member toward the head of the lure member. The motionless, slow, downward fall action is achieved by the dying bait fish lure being close to neutral buoyancy in water with a slight weight of the weight member applied toward the head of the lure member. The weight member is further configured to pivot the lure member in an upward direction during the retrieval of the fishing line and to pivot the lure member in a downward direction when tension in the fishing line is reduced and the retrieval of the fishing line is paused to allow the dying bait fish lure to fall naturally. The weight member is slightly positioned toward the head of the lure member to enable the fall to be head first. The hook element(s) is attached to one or more predetermined locations of the lure member. For example, one hook element is attached to a lower mid-section of the body of the lure member and another hook element is attached to the tail of the lure member. The hook element(s) can be of various types and made from various materials. One or more hook elements are disposed at optimum locations of the lure member, for example, midway along the belly and the tail of the lure member. The hook element(s) is attached to a connector, for example, an eyelet, mounted on each of the optimum locations of the lure member. The eyelet is disposed on a front nose end of the lure member for allowing a connection to the fishing line. The eyelet is configured to connect the fishing line to the lure member. In an embodiment, the dying bait fish lure further comprises a split ring connected to the eyelet. The split ring is configured to connect the fishing line to the lure member. The weight member and its positioning in combination with the diving lip member attached to the top of the head of the lure member allow the dying bait fish lure to execute the injured or dying bait fish action.

In another embodiment, the dying bait fish lure comprises a lure member, an eyelet, a lip member, a weight member, and two hook elements. In this embodiment, the lure member comprises a head, a partial upper body, and an extended lower body. The head, the partial upper body, and the extended lower body define a partially open cavity configured to accommodate a bait, for example, a live bait, an artificial bait, etc. The bait is attached to the head or the partial upper body of the lure member using a securing element, for example, a pin, a clip, a safety pin, etc. The eyelet is disposed on a front nose end of the lure member. The eyelet is configured to connect a fishing line to the lure member. In an embodiment, the dying bait fish lure further comprises a split ring connected to the eyelet for connecting the fishing line to the lure member. The lip member is disposed dorsally behind and above the head of the lure member. The weight member is disposed at a location between a center of the extended lower body and the head of the lure member. A horizontal interception of the location of the weight member is along a center line of the extended lower body of the lure member, with a center of the weight member disposed slightly forward of a central balance point of the lure member, toward the head of the lure member, to cause a head-first dive in water when tension in the fishing line is reduced. The weight member is configured to maintain the extended lower body of the lure member in a downward position while keeping the lip member facing in an upward direction for a straight, upward swim action of the dying bait fish lure during retrieval of the fishing line. The structure and the functions of the lip member and the weight member are as disclosed above. A first hook element is attached to a mid-section of the extended lower body of the lure member, and a second hook element is attached to a distal end of the lure member. In an embodiment, the dying bait fish lure further comprises a flexible line member configured to connect the first hook element to the second hook element. The second hook element is configured to hook the bait, for example, a live bait, an artificial bait, etc., to the lure member, thereby allowing the bait to undulate in water.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components, structures, and methods disclosed herein. The description of a component or a structure referenced by a numeral in a drawing is applicable to the description of that component or structure shown by that same numeral in any subsequent drawing herein. The terms “front”, “rear”, “side”, “top”, “bottom”, “upper”, “lower”, “interior”, etc., are based on an orientation or a positional relationship shown in the appended drawings, and are recited merely for describing the embodiments herein, rather than indicating or implying that the component or structure referenced must have a particular orientation or position or must be constructed and operated in a particular orientation, and therefore should not be construed as limiting the embodiments herein.

FIG. 1A illustrates a side perspective view of an embodiment of a dying bait fish lure.

FIG. 1B illustrates a top elevation view of the embodiment of the dying bait fish lure shown in FIG. 1A.

FIG. 1C illustrates a top elevation view showing a head, a body, and a tail of the embodiment of the dying bait fish lure shown in FIG. 1A, and a lip member attached above the head of the dying bait fish lure.

FIG. 1D illustrates a cross-sectional view of the embodiment of the dying bait fish lure shown in FIG. 1A, taken along a sectional line A-A′ shown in FIG. 1C.

FIG. 1E illustrates a top, rear perspective view of the embodiment of the dying bait fish lure shown in FIG. 1A.

FIGS. 2A-2B illustrate perspective views showing a dying bait fish action comprising a straight, upward swim action followed by a dead, motionless, slow, downward fall action of the dying bait fish lure shown in FIG. 1E.

FIG. 3A illustrates a top, rear perspective view of another embodiment of the dying bait fish lure.

FIG. 3B illustrates a cross-sectional view of the embodiment of the dying bait fish lure shown in FIG. 3A, taken along a sectional line B-B′ shown in FIG. 3A.

FIG. 4A illustrates a top, rear perspective view of the embodiment of the dying bait fish lure shown in FIG. 3A, showing a bait accommodated within and attached to a lure member of the dying bait fish lure.

FIG. 4B illustrates a side perspective view of the embodiment of the dying bait fish lure with the bait shown in FIG. 4A.

FIG. 4C illustrates a top elevation view of the embodiment of the dying bait fish lure with the bait shown in FIG. 4A.

FIG. 4D illustrates a bottom elevation view of the embodiment of the dying bait fish lure with the bait shown in FIG. 4A.

### DETAILED DESCRIPTION OF THE INVENTION

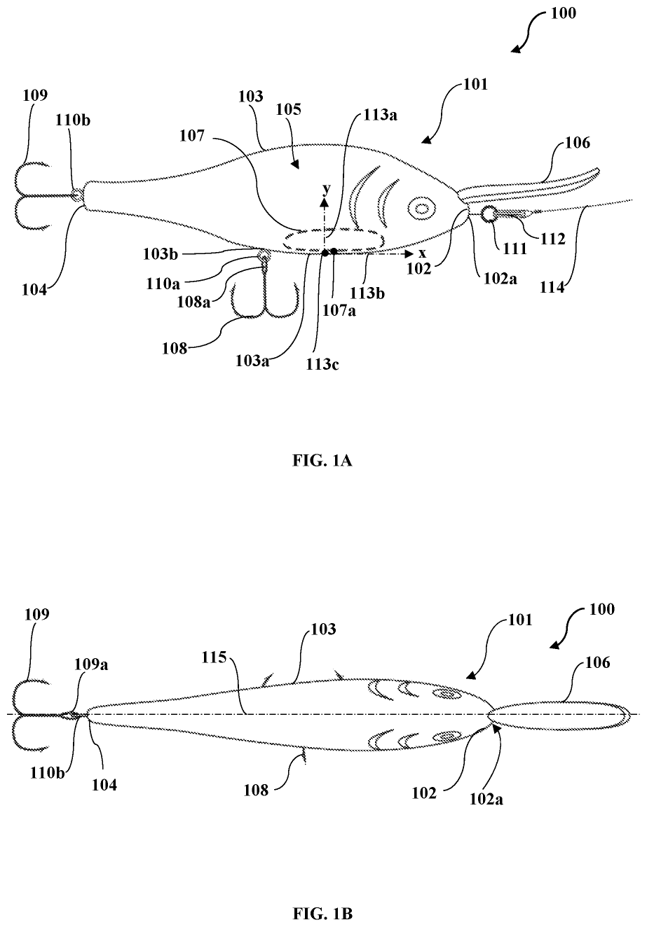

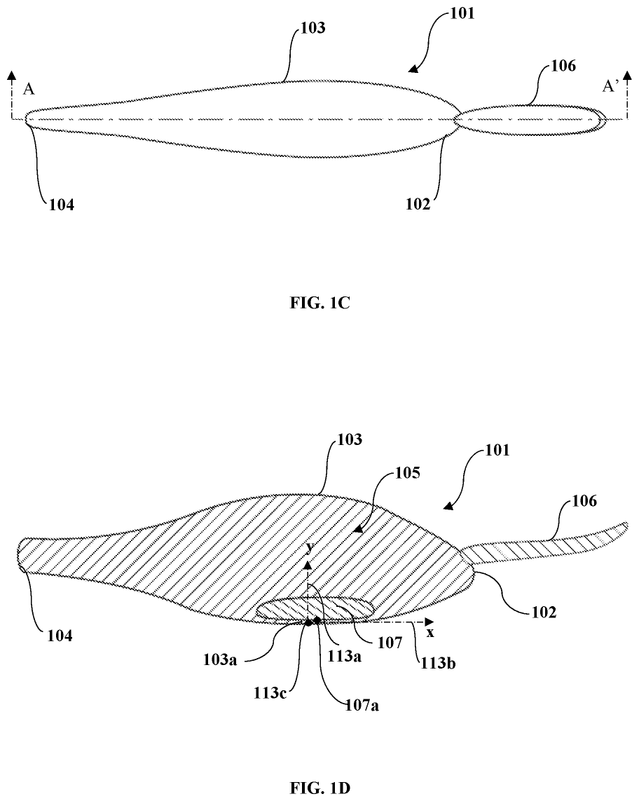

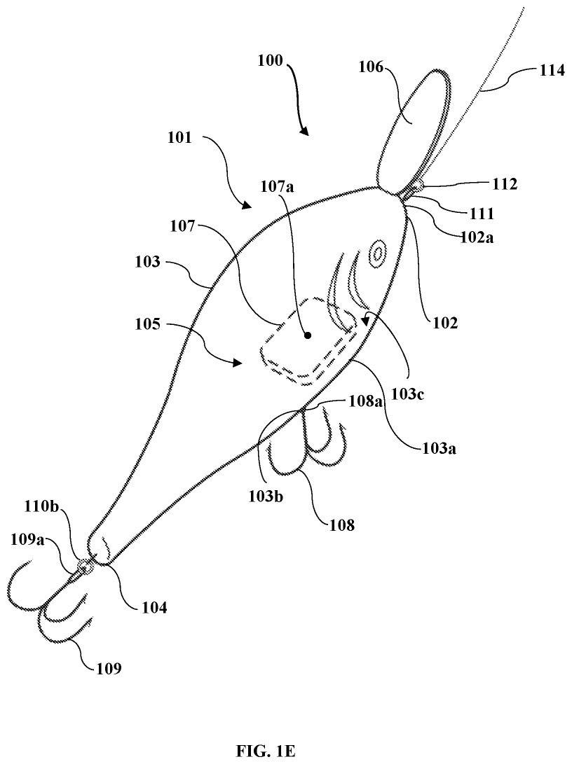

FIG. 1A and FIG. 1B illustrate a side perspective view and a top elevation view, respectively, of an embodiment of a dying bait fish lure 100. The dying bait fish lure 100 is configured to simulate various distressed fish actions in water. The dying bait fish lure 100 disclosed herein comprises a lure member 101, a lip member 106, a weight member 107, one or more hook elements 108 and 109, and an eyelet 111. The lure member 101 is configured to resemble a bait fish, for example, a minnow, comprising a head 102, a solid body 103, and a tail 104. The head 102, the body 103, and the tail 104 define an interior cavity 105 within the lure member 101. In an embodiment, the lure member 101 is shaped like a bait fish, for example, a minnow. Although the disclosure herein refers to simulating the action of a dying minnow, the dying bait fish lure 100 disclosed herein is not limited to simulating the action of a dying minnow, but is extended to simulating erratic actions of any injured, wounded, fleeing, struggling, ailing, distressed, or dying bait fish in water. When viewed from the side as illustrated in FIG. 1A and from the top as illustrated in FIG. 1B, the lure member 101 is generally longitudinal, having a longitudinal axis 115 running from a front nose end 102a to a tail end 104 as illustrated in FIG. 1B. In an embodiment, the lure member 101 is made of a hard plastic material having neutral buoyancy. In another embodiment, the lure member 101 is made of a soft plastic material having neutral buoyancy. In another embodiment, the lure member 101 is molded from malleable plastic materials, for example, thermoplastics, thermosetting plastics, etc. In another embodiment, the lure member 101 is colored to create a realistic appearance of a bait fish, for example, a minnow, using colored plastics or rubber materials.

The lip member 106 is disposed dorsally behind and above the head 102 of the lure member 101. The lip member 106 extends outwardly above the head 102 of the lure member 101. In an embodiment, the lip member 106 is glued above the head 102 of the lure member 101 using adhesive materials. In another embodiment, the lip member 106 is inserted above the head 102 of the lure member 101 and attached thereto using fasteners or attachment elements, for example, screws, wires, adhesive materials, etc. In another embodiment, the lip member 106 is molded above the head 102 of the lure member 101 as an integral part of the lure member 101. That is, the lip member 106 is molded with the lure member 101 above the head 102 of the lure member 101 as one piece. The lip member 106 is configured to provide direction to the dying bait fish lure 100 and facilitate a dying bait fish action, for example, a dying minnow action, comprising a straight, upward swim action followed by a dead, motionless, slow, downward fall action of the dying bait fish lure 100. The straight, upward swim action occurs during retrieval of a fishing line 114 that is connected to the eyelet 111 of the dying bait fish lure 100. The dead, motionless, slow, downward fall action occurs when the retrieval of the fishing line 114 is paused. In an embodiment, the lip member 106 is a curved, generally ovular-shaped member configured in one of multiple variable sizes for facilitating multiple actions and upward movements of the dying bait fish lure 100. The lip member 106 is proportional to the size of the lure member 101. In an embodiment, the width of the lip member 106 is generally similar to or the same as the width of the head 102 of the lure member 101. In another embodiment, the width of the lip member 106 is slightly wider than the width of the head 102 of the lure member 101. The length of the lip member 106 determines the intensity of the rise of the dying bait fish lure 100 in an upward direction. For example, a larger or longer lip member 106 rises faster with a substantially vertical alignment in the upward direction. In an example, a lip member 106 having a width of about ½ inch and a length of about ¾ inch to about 1 inch is configured for a 4-inch long lure member 101. The size of the lip member 106 is variable based on the required climb and action of the dying bait fish lure 100.

The weight member 107 of the dying bait fish lure 100 is disposed in the interior cavity 105 of the lure member 101, at a location between a center of the body 103 and the head 102 of the lure member 101. The size of the dying bait fish lure 100 being used determines overall size of the weight member 107. The length of the weight member 107 is, for example, about 1 inch. In an example, weight of a 1-inch long weight member 107 is about ⅛ ounce to about ¼ ounce. The weight of the weight member 107 is variable based on the required action of the dying bait fish lure 100. A center 107a of the weight member 107 illustrated in FIG. 1A and FIGS. 1D-1E, is positioned slightly forward of the y-axis 113a as illustrated in FIG. 1A and FIG. 1D, to cause the downward fall of the dying bait fish lure 100 to be head-first. A horizontal interception of the location of the weight member 107 is along a lower center line of a belly 103a of the lure member 101, with the center 107a of the weight member 107 disposed slightly forward of a central balance point 113c of the lure member 101 as illustrated in FIG. 1A and FIG. 1D, toward the head 102 of the lure member 101, to cause a head-first dive of the dying bait fish lure 100 in water when tension in the fishing line 114 is reduced. As used herein, “horizontal interception” refers to a point where the y-axis 113a intercepts the weight member 107, which is to the left of the center 107a of the weight member 107 as illustrated in FIG. 1A and FIG. 1D. The weight member 107 is configured to maintain the belly 103a of the lure member 101 in a downward position while keeping the lip member 106 facing in an upward direction for a straight, upward swim action of the dying bait fish lure 100 during retrieval of the fishing line 114.

The weight member 107 is configured to maintain an upright balance and execute the motionless, slow, downward fall action of the dying bait fish lure 100 by weight distribution of the weight member 107 being slightly forward of the central balance point 113c of the lure member 101 toward the head 102 of the lure member 101. The motionless, slow, downward fall action is achieved by the dying bait fish lure 100 being close to neutral buoyancy in water with a slight weight of the weight member 107 applied towards the head 102 of the lure member 101. Neutral buoyancy occurs when average density of the dying bait fish lure 100 is equal to the density of the water in which the dying bait fish lure 100 is immersed, resulting in the buoyant force balancing the force of gravity that would otherwise cause the dying bait fish lure 100 to sink or rise. If the density of the dying bait fish lure 100 is greater than the density of the water in which the dying bait fish lure 100 is immersed, the dying bait fish lure 100 sinks. If the density of the dying bait fish lure 100 is less than the density of the water in which the dying bait fish lure 100 is immersed, the dying bait fish lure 100 rises. At neutral buoyancy, without adding the weight member 107, the dying bait fish lure 100 does not float or sink but stays in its original position at a water level. The weight member 107 controls the position of the dying bait fish lure 100 and maintains the belly 103a of the lure member 101 in a downward position when the dying bait fish lure 100 dives in a downward direction. Without the weight member 107, the natural tendency of the dying bait fish lure 100 causes the belly 103a of the lure member 101 to be in an upward position, as the weight of the lip member 106 above the head 102 of the lure member 101 causes the lure member 101 to turn the lip member 106 to a downward position and the belly 103a of the lure member 101 to an upward position, thereby causing the dying bait fish lure 100 to dive in a downward direction. The weight member 107 positioned in the belly 103a of the lure member 101 keeps the dying bait fish lure 100 positioned to travel in an upward direction during retrieval of the fishing line 114 and to fall in a downward direction when the fishing line 114 is relaxed and the retrieval of the fishing line 114 is paused.

The weight member 107 is slightly positioned toward the head 102 of the lure member 101 to enable the fall to be head-first. The weight member 107 is further configured to pivot the lure member 101 in an upward direction during retrieval of the fishing line 114 and to pivot the lure member 101 in a downward direction when tension in the fishing line 114 is reduced and the retrieval of the fishing line 114 is paused to allow the dying bait fish lure 100 to fall naturally. During retrieval of the fishing line 114 in a retrieve mode, the purpose and effect of the weight member 107 is to keep the belly 103a of the lure member 101 weighted down, to preclude the dying bait fish lure 100 from going belly-up and diving in a downward direction. In an embodiment, the shape of the weight member 107 is a generally rectangular shape as illustrated in FIG. 1E, with an extended length for weight distribution within the lure member 101. In another embodiment, the shape of the weight member 107 is a generally ovular shape with an extended length for weight distribution within the lure member 101.

The hook elements 108 and 109 of the dying bait fish lure 100 are attached to predetermined locations of the lure member 101. For example, one hook element 108 is attached to a lower mid-section 103b of the body 103 of the lure member 101 and another hook element 109 is attached to the tail 104 of the lure member 101. The eyes 108a and 109a of the hook elements 108 and 109, respectively, are connected to the lower mid-section 103b of the body 103 of the lure member 101 and to the tail 104 of the lure member 101 via connectors 110a and 110b, respectively. The connectors 110a and 110b are, for example, ring-shaped connectors such as eyelets, attached to the lower mid-section 103b of the body 103 of the lure member 101 and to the tail 104 of the lure member 101, respectively, as illustrated in FIGS. 1A-1B. The hook elements 108 and 109 are, for example, treble hooks, as illustrated in FIGS. 1A-1B and FIG. 1E. In an embodiment, the hook elements 108 and 109 are selected, for example, from single hooks, double hooks, treble hooks, J-shaped hooks, circle hooks, etc., or any combination thereof. The hook elements 108 and 109 are configured to trail from the lower mid-section 103b of the body 103 of the lure member 101 and from the tail 104 of the lure member 101, respectively. The hook elements 108 and 109 are configured to pierce or hook the mouth of a target game fish to catch the target game fish. The hook elements 108 and 109 are made, for example, from high-carbon steel, stainless steel, steel alloys, etc. The size of each of the hook elements 108 and 109 is proportional to the size of the lure member 101. In an example, the size of each of the hook elements 108 and 109 is one of size 8, size 6, size 4, and size 2 depending on the size of the lure member 101, where size 8 is smaller than size 2.

The eyelet 111 of the dying bait fish lure 100 is disposed on the front nose end 102a of the lure member 101. The eyelet 111 is connected to and extends from the front nose end 102a of the head 102 of the lure member 101. The eyelet 111 is made of metal, for example, stainless steel, brass, aluminum, or other durable and corrosion-resistant materials. The eyelet 111 is configured to connect the fishing line 114 to the lure member 101. The size of the eyelet 111 is, for example, about 0.125 inch. In an embodiment, the dying bait fish lure 100 further comprises a split ring 112 connected to the eyelet 111. The split ring 112 is configured to connect the fishing line 114 to the lure member 101 via the eyelet 111. The split ring 112 is a metal loop used as an attachment point for the fishing line 114. The split ring 112 is made, for example, from stainless steel, brass, copper, etc.

FIG. 1C illustrates a top elevation view showing the head 102, the body 103, and the tail 104 of the embodiment of the dying bait fish lure 100 shown in FIG. 1A, and the lip member 106 attached above the head 102 of the dying bait fish lure 100. The lure member 101 is made, for example, from plastics, resins, hollow metal, wood, etc. The length of the lure member 101 is, for example, about 2.5 inches to about 7 inches, based on the species of predatory fish to be attracted. The lip member 106 which imparts direction and swimming action to the dying bait fish lure 100 is permanently placed dorsally just behind and above the head 102 of the lure member 101. Dorsal placement of the lip member 106 above the head 102 of the lure member 101 causes the dying bait fish lure 100 to perform a straight, upward swimming action when retrieved. The size of the lip member 106 can be varied. The size of the lip member 106 is configured to be large enough to facilitate the upward swim action of the dying bait fish lure 100 during retrieval of the fishing line 114. Lip members 106 of different sizes can be attached to different models of the dying bait fish lure 100 to cause changes in action and upward motion of the dying bait fish lure 100. In an example, the length of the lip member 106 is more than about 0.75 inches proportionate to the size of the lure member 101. In an embodiment, the lip member 106 is made of a material different from the material of the head 102 and the body 103 of the lure member 101 for aesthetics or for adding or lessening weight at the head 102 of the lure member 101 to effect buoyancy of the dying bait fish lure 100 in water. Examples of materials used to manufacture the lip member 106 comprise plastic, metal, fiberglass, resin, etc.

FIG. 1D illustrates a cross-sectional view of the embodiment of the dying bait fish lure 100 shown in FIG. 1A, taken along a sectional line A-A′ shown in FIG. 1C. The cross-sectional view in FIG. 1D indicates the position of the weight member 107 against the belly 103a of the lure member 101. The cross-sectional view in FIG. 1D also indicates the horizontal interception of the location of the weight member 107 along the lower center line of the belly 103a of the lure member 101. The center 107a of the weight member 107 is disposed slightly forward of the central balance point 113c of the lure member 101, toward the head 102 of the lure member 101. By having the center 107a of the weight member 107 positioned slightly toward the head 102 of the lure member 101 from the central balance point 113c of the lure member 101 as illustrated in FIGS. 1D-1E, the head 102 of the lure member 101 is able to pivot in a downward direction when the fishing line 114 is relaxed. The dying bait fish lure 100 balances at the central balance point 113c of the lure member 101 prior to the addition of the weight member 107. As illustrated in FIGS. 1D-1E, the weight member 107 lies on the x-axis 113b with the extended length of the weight member 107 disposed on each side of the y-axis 113a for distribution of weight on both sides of the y-axis 113a. The y-axis 113a intercepts the x-axis 113b a short distance to the rear left of the weight member 107 with more of the weight member 107 across the y-axis 113a toward the head 102 of the lure member 101.

FIG. 1E illustrates a top, rear perspective view of the embodiment of the dying bait fish lure 100 shown in FIG. 1A. In an embodiment, the weight member 107 is attached to an inner surface 103c of the belly 103a of the lure member 101, for example, using glue, wire, etc. In another embodiment, the weight member 107 is disposed within a compartment (not shown) molded into the belly 103a of the lure member 101. The weight member 107 is made, for example, from lead, any type of metal, dense plastic, etc. In an embodiment, the weight member 107 is of a generally rectangular shape and is configured to have a low profile and remain low against the belly 103a of the lure member 101 as illustrated in FIG. 1E. The weight member 107 is configured to have an extended length to distribute weight on both sides of the y-axis 113a illustrated in FIG. 1A and FIG. 1D. Furthermore, the amount of weight of the weight member 107 determines speed of the downward fall action, for example, a slow fall or a fast fall. The angler and fishing situations and conditions determine the choice of the weight member 107 used. The weight member 107 and its positioning in combination with the diving lip member 106 attached to the top of the head 102 of the lure member 101 allow the dying bait fish lure 100 to execute the injured or dying bait fish action. The lip member 106 is positioned above the head 102 of the lure member 101 to guide the motion of the dying bait fish lure 100, thereby facilitating the dying minnow action during retrieval of the fishing line 114 while the dying bait fish lure 100 swims in a straight upward direction.

The weight member 107 disposed in the interior cavity 105 of the lure member 101 along the lower center line of the belly 103a of the lure member 101 keeps the belly 103a of the lure member 101 in a downward direction. Without the weight member 107, the belly 103a of the lure member 101 would be on the upward side of the lure member 101 due to the weight of the lip member 106, which flips the lure member 101 and makes the top side of the lure member 101 to be on the bottom. The placement of the weight member 107 in the belly 103a of the lure member 101 counteracts the weight of the lip member 106 and keeps the belly side down and the lip member 106 facing upward. Due to the weight member 107 in the belly 103a of the lure member 101 causing the lip member 106 to be in the upward position during retrieval of the fishing line 114, the lip member 106 digs into the water in an upward direction, and with all the components of the dying bait fish lure 100, that is, the lure member 101, the upward facing lip member 106, and the weight member 107, properly matched, the retrieval of the fishing line 114 makes the dying bait fish lure 100 travel in a straight, upward direction. Proper matching of the components of the dying bait fish lure 100 refers to the lure member 101 being close to natural buoyancy, the lip member 106 facing upward, and the weight member 107 being properly placed slightly towards the head 102 of the lure member 101 from the central balance point 113c of the lure member 101 to cause the head 102 of the lure member 101 to pivot down and fall slowly when the fishing line 114 is relaxed. The weight member 107 being placed slightly forward of the central balance point 113c of the lure member 101 illustrated n FIG. 1A and FIG. 1D causes the dying bait fish lure 100 to fall head-first in a downward direction when tension on the fishing line 114 is relaxed.

In practical use, an angler attaches the fishing line 114 to the eyelet 111 of the dying bait fish lure 100, imparts motion to the dying bait fish lure 100, and initiates retrieval of the fishing line 114 to invoke a dying bait fish action, for example, a dying minnow action, to attract target game fish. Retrieval of the fishing line 114 causes the dying bait fish lure 100 to swim in a straight, upward direction. Relaxing the fishing line 114 causes the dying bait fish lure 100 to pivot and fall downward head-first due to the positioning of the weight member 107 being slightly forward toward the head 102 of the lure member 101. The fall action is optimal when slow to mimic a natural dying bait fish, for example, a dying minnow. The slow fall action is achieved by the dying bait fish lure 100 being near neutral buoyancy. The upward darting and slow falling action is the desired dying bait fish action achieved by the dying bait fish lure 100, which in turn provokes a predatory response from the target game fish.

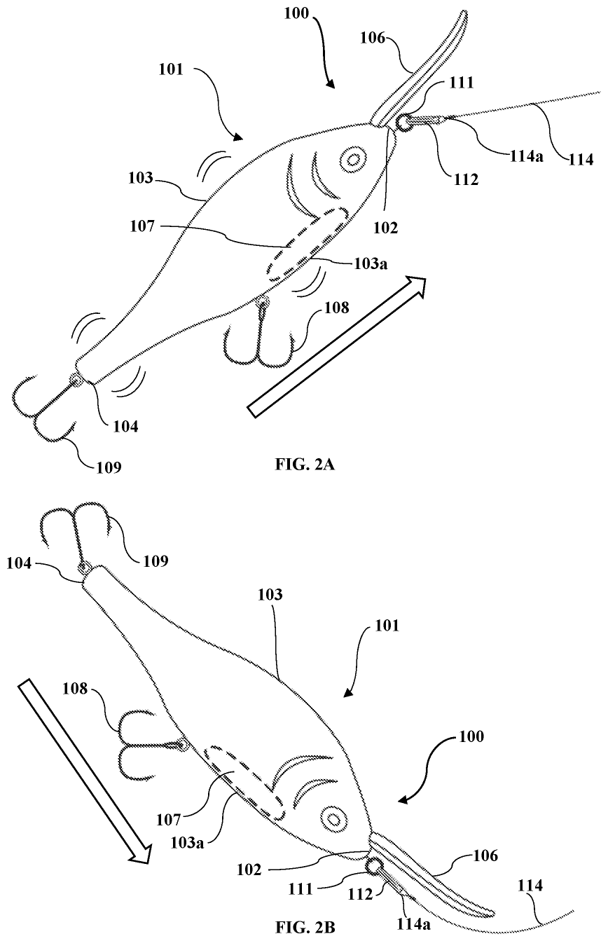

FIGS. 2A-2B illustrate perspective views showing a dying bait fish action comprising a straight, upward swim action followed by a dead, motionless, slow, downward fall action of the dying bait fish lure 100 shown in FIG. 1E. When an angler retrieves a fishing line 114 connected to the split ring 112 on the eyelet 111 of the dying bait fish lure 100 in water during angling, the dying bait fish lure 100 darts through the water, simulates the maneuvers of an injured or dying bait fish, for example, an injured or dying minnow, and performs a swimming action similar to the injured or dying minnow, which comprises swimming in a straight, upward direction. The weight member 107 maintains the belly 103a of the lure member 101 in a downward position while keeping the lip member 106 facing in an upward direction for a straight, upward swim action of the dying bait fish lure 100 during retrieval of the fishing line 114. When the angler pauses the retrieval of the fishing line 114 by relaxing or releasing the fishing line 114, the dying bait fish lure 100 performs a dead, motionless, slow, downward fall action and falls in a downward direction. The weight member 107, disposed slightly forward of the central balance point 113c of the lure member 101 illustrated in FIG. 1A and FIG. 1D, toward the head 102 of the lure member 101, causes a head-first dive of the dying bait fish lure 100 in water when tension in the fishing line 114 is reduced. The straight, upward swim action of the dying bait fish lure 100 is indicated by the direction of an upward arrow illustrated in FIG. 2A. The dead, motionless, slow, downward fall action of the dying bait fish lure 100 is indicated by the direction of a downward arrow illustrated in FIG. 2B. The weight member 107 pivots the lure member 101 in the upward direction during the retrieval of the fishing line 114 as illustrated in FIG. 2A, and pivots the lure member 101 in the downward direction when the tension in the fishing line 114 is reduced and the retrieval of the fishing line 114 is paused to allow the dying bait fish lure 100 to fall naturally as illustrated in FIG. 2B.

Consider an example where an angler attempts to catch a target game fish using the dying bait fish lure 100. The angler first loops and ties the distal end 114a of a fishing line 114 to the split ring 112 on the eyelet 111 of the dying bait fish lure 100 and then throws or hurls the fishing line 114 with the dying bait fish lure 100 over water using a fishing rod and a fishing reel in a cast mode. The angler then starts to trigger a dying minnow action of the dying bait fish lure 100 by initiating retrieval of the fishing line 114 across the water. The dying bait fish lure 100, while referred to as simulating the action of a dying minnow, is also configured to simulate various distressed fish actions in water. During the initial retrieval of the fishing line 114 toward the angler, the angler may sweep the fishing rod sideways and perform jigging movements with the tip of the fishing rod. The sweeping and jigging movements of the fishing rod in the retrieve mode invoke the dying minnow action of the dying bait fish lure 100, where the dying bait fish lure 100 swims in an upward direction during the initial retrieval of the fishing line 114 due to structure and placement of the lip member 106 and the strategically placed balance weight member 107 in the belly 103a of the lure member 101, and thereafter slowly falls head-first when the angler pauses the retrieval of the fishing line 114. The angler's actions with the fishing rod cause the dying bait fish lure 100 to repeatedly dart and swim in the upward direction, and then fall slowly as though dying many times until death, to lure the target game fish. This dying minnow action of the dying bait fish lure 100 may invoke and cause a predatory and instinctive reaction from the target game fish, which observes the upward movement and downward fall of the dying bait fish lure 100 and bites the dying bait fish lure 100, thereby getting caught in the hook elements 108 and 109 of the dying bait fish lure 100.

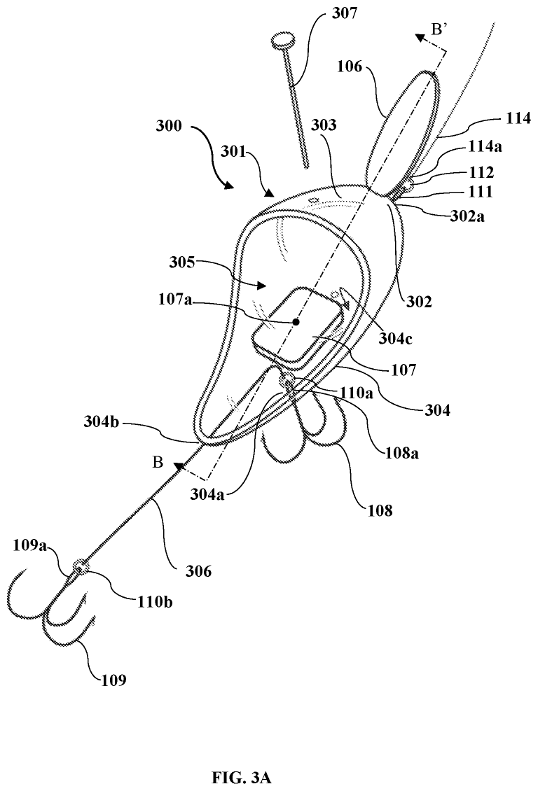

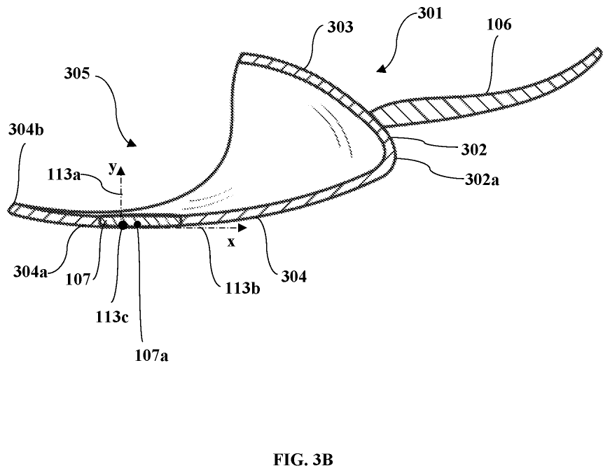

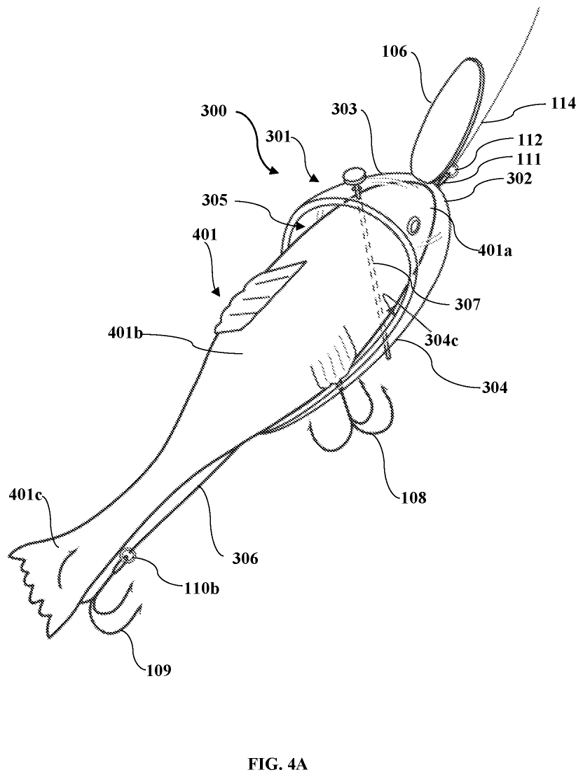

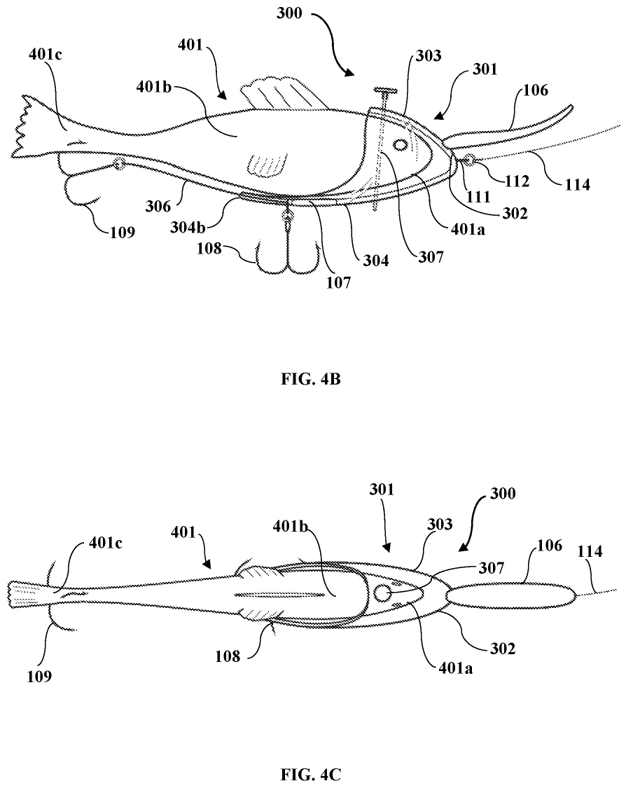

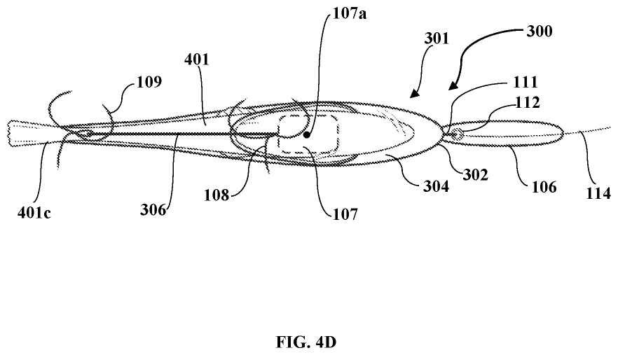

FIG. 3A illustrates a top, rear perspective view of another embodiment of the dying bait fish lure 300. This embodiment of the dying bait fish lure 300 comprises components and performs actions similar to those of the dying bait fish lure 100 illustrated in FIGS. 1A-1E, with variations in the design of the lure member 301 comprising a partially open cavity 305 for live or artificial bait 401 illustrated in FIGS. 4A-4D. In this embodiment, the dying bait fish lure 300, not having a complete lure body continuing to the tail, comprises a partial upper body 303 which is open, allowing scent and sight to target game fish or predatory fish, while a hook element 109 is provided for attachment to the live or artificial bait 401 and another hook element 108 is attached with a flexible line member 306 to an extended lower body 304 near the head 302 of the lure member 301.

As illustrated in FIG. 3A, the dying bait fish lure 300 comprises a lure member 301, an eyelet 111, a lip member 106, a weight member 107, and two hook elements 108 and 109. In this embodiment, the lure member 301 comprises a head 302, a partial upper body 303, and an extended lower body 304. The head 302, the partial upper body 303, and the extended lower body 304 define a partially open cavity 305 configured to accommodate a bait 401, for example, a live bait, an artificial bait, etc. Examples of live bait comprise a live minnow, a nightcrawler worm, etc. Examples of artificial bait comprise spoons, jigs, spinning lures, crankbaits, etc. The bait 401 is attached to the head 302 or the partial upper body 303 of the lure member 301 using a securing element 307, for example, a pin, a clip, a safety pin, etc. In an embodiment, an upper part of the lure member 101 illustrated in FIG. 1E is cut at a predetermined angle to form the structure of the lure member 301 illustrated in FIG. 3A. In an embodiment, the lure member 301 is made of a hard plastic material having neutral buoyancy. In another embodiment, the lure member 301 is made of a soft plastic material having neutral buoyancy. In another embodiment, the lure member 301 is made from clear or transparent plastic. In another embodiment, the lure member 301 is made, for example, from plastics, resins, hollow metal, wood, etc.

The eyelet 111 of the dying bait fish lure 300 is disposed on a front nose end 302a of the lure member 301 for connection to a fishing line 114. The front nose end 302a is opposite to a distal end 304b of the extended lower body 304 of the lure member 301. In an embodiment, the dying bait fish lure 300 further comprises a split ring 112 connected to the eyelet 111 for connecting the fishing line 114 to the lure member 301. One end 114a of the fishing line 114 is looped and tied to the split ring 112 on the eyelet 111. The structure, material, dimensions, and functions of the eyelet 111 and the split ring 112 are disclosed in the description of FIGS. 1A-1B. The lip member 106 of the dying bait fish lure 300 is disposed dorsally behind and above the head 302 of the lure member 301. The lip member 106 is configured to provide direction to the dying bait fish lure 300 and facilitate a dying bait fish action, for example, a dying minnow action, comprising a straight, upward swim action during retrieval of the fishing line 114 followed by a dead, motionless, slow, downward fall action when the retrieval of the fishing line 114 is paused.

The weight member 107 is disposed at a location between a center of the extended lower body 304 and the head 302 of the lure member 301. A horizontal interception of the location of the weight member 107 is along a center line of the extended lower body 304 of the lure member 301, with the center 107a of the weight member 107 illustrated in FIG. 3A and FIG. 4D disposed slightly forward of the central balance point 113c of the lure member 301 illustrated in FIG. 3B, toward the head 302 of the lure member 301, to cause a head-first dive of the dying bait fish lure 300 in water when tension in the fishing line 114 is reduced. The weight member 107 is configured to maintain the extended lower body 304 of the lure member 301 in a downward position while keeping the lip member 106 facing in an upward direction for a straight, upward swim action of the dying bait fish lure 300 during the retrieval of the fishing line 114. The structure, material, dimensions, and functions of the lip member 106 and the weight member 107 are disclosed in the descriptions of FIGS. 1A-1E. In an embodiment as illustrated in FIGS. 3A-3B and FIG. 4D, the weight member 107 is a generally rectangular-shaped weight member embedded in a flat, horizontal position within the extended lower body 304 of the lure member 301. The length of the weight member 107 is extended for weight distribution within the lure member 301. The weight member 107 is configured to maintain an upright balance and execute the motionless, slow, downward fall action of the dying bait fish lure 300 by weight distribution of the weight member 107 being slightly forward of the central balance point 113c of the lure member 301 toward the head 302 of the lure member 301. The motionless, slow, downward fall action is achieved by the dying bait fish lure 300 being close to neutral buoyancy in water with a slight weight of the weight member 107 applied toward the head 302 of the lure member 301. The weight member 107 is further configured to pivot the lure member 301 in an upward direction during the retrieval of the fishing line 114 and to pivot the lure member 301 in a downward direction when the tension in the fishing line 114 is reduced and the retrieval of the fishing line 114 is paused to allow the dying bait fish lure 300 to fall naturally.

A first hook element 108 is attached to a mid-section 304a of the extended lower body 304 of the lure member 301, and a second hook element 109 is attached to the distal end 304b of the lure member 301. The terms “first” and “second” are used herein for descriptive purposes only and are not to be construed to indicate or imply relative importance. In an embodiment, the dying bait fish lure 300 further comprises a flexible line member 306 configured to connect the first hook element 108 to the second hook element 109 as illustrated in FIG. 3A and FIGS. 4A-4B and FIG. 4D. The flexible line member 306 is connected between the first hook element 108 and the second hook element 109 via connectors 110a and 110b, respectively. The connectors 110a and 110b, for example, eyelets, are attached to the eyes 108a and 109a of the first hook element 108 and the second hook element 109, respectively. The second hook element 109 is configured to hook the bait 401 to the lure member 301 as illustrated in FIGS. 4A-4D, thereby allowing the bait 401 to undulate in water. The thin flexible line member 306 extending from the first hook element 108 to the second hook element 109 to be attached to the bait 401 allows the bait 401 to be exposed and undulate when pulled through the water. The lip member 106 causes the dying bait fish lure 300 to dive in an upward direction and causes an undulating effect. In an embodiment, the hook elements 108 and 109 are treble hooks as illustrated in FIG. 3A and FIGS. 4A-4D. In another embodiment, the hook elements 108 and 109 are selected, for example, from single hooks, double hooks, treble hooks, J-shaped hooks, circle hooks, etc., or any combination thereof.

FIG. 3B illustrates a cross-sectional view of the embodiment of the dying bait fish lure 300 shown in FIG. 3A, taken along a sectional line B-B′ shown in FIG. 3A. The cross-sectional view in FIG. 3B illustrates the lip member 106 extending outwardly above the head 302 of the lure member 301. The cross-sectional view in FIG. 3B also illustrates the weight member 107 embedded or implanted in a flat, horizontal position within the extended lower body 304 of the lure member 301. In an embodiment, the weight member 107 is attached to an upper surface 304c of the extended lower body 304 of the lure member 301 illustrated in FIG. 3A. In another embodiment, the weight member 107 is disposed within a compartment (not shown) molded into the mid-section 304a of the lure member 301. The center 107a of the weight member 107 is disposed slightly forward of the central balance point 113c of the lure member 301, toward the head 302 of the lure member 301. The weight member 107 lies on the x-axis 113b with the extended length of the weight member 107 disposed on each side of the y-axis 113a for distribution of weight on both sides of the y-axis 113a.

FIG. 4A, FIG. 4B, and FIG. 4C illustrate a top, rear perspective view, a side perspective view, and a top elevation view, respectively, of the embodiment of the dying bait fish lure 300 shown in FIG. 3A, showing a bait 401 accommodated within and attached to the lure member 301 of the dying bait fish lure 300. The bait 401 is, for example, a live bait such as a live minnow or other bait fish, insects, worms such as nightcrawler worms, freshwater crustaceans such as crayfish, etc., that can be accommodated in the partially open cavity 305 of the lure member 301. In another example, the bait 401 is an artificial bait such as a spoon, a jig, a spinning lure, a crankbait, etc., that can be accommodated in the partially open cavity 305 of the lure member 301. The bait 401 is inserted into the partially open cavity 305 of the lure member 301 such that the head 401a of the bait 401 is securely disposed below the partial upper body 303 of the lure member 301. The head 401a of the bait 401 fits within the head 302 of the lure member 301, while the body 401b of the bait 401 rests on the upper surface 304c of the extended lower body 304 of the lure member 301. The bait 401 is attached to the partial upper body 303 of the lure member 301 using a securing element 307, for example, a pin, as illustrated in FIGS. 4A-4C. An angler holds the bait 401 in position within the partially open cavity 305 of the lure member 301 and inserts the securing element 307 through the partial upper body 303 of the lure member 301, into the bait 401, and then through the extended lower body 304 of the lure member 301 to secure the bait 401 to the lure member 301. In an embodiment, the bait 401 is attached to the head 302 of the lure member 301 using the securing element 307. One of the hook elements, for example, the hook element 109, is hooked to the tail 401c of the bait 401.

FIG. 4D illustrates a bottom elevation view of the embodiment of the dying bait fish lure 300 with the bait 401 shown in FIG. 4A. The bottom elevation view in FIG. 4D illustrates the weight member 107 lying flat on the extended lower body 304 of the lure member 301. The bottom elevation view in FIG. 4D also illustrates the tail 401c of the bait 401 pierced by the hook element 109 for securing the bait 401 to the lure member 301. The bottom elevation view in FIG. 4D also illustrates the flexible line member 306 that extends from the first hook element 108 to the second hook element 109, which allows the bait 401 attached to the second hook element 109 to be exposed and undulate when pulled through water.

Consider an example where an angler attempts to catch a target game fish using the dying bait fish lure 300. The angler first loops and ties the distal end 114a of a fishing line 114 to the split ring 112 on the eyelet 111 of the dying bait fish lure 300. The angler then inserts a bait 401, for example, a live minnow, into the partially open cavity 305 of the lure member 301 and secures the bait 401 therewithin by inserting a securing element 307, for example, a pin, through the partial upper body 303 of the lure member 301, into the bait 401, and then through the extended lower body 304 of the lure member 301. After securing the bait 401 to the dying bait fish lure 300, the angler throws or hurls the fishing line 114 with the dying bait fish lure 300 over water using a fishing rod and a fishing reel in a cast mode. The angler then starts to trigger a dying minnow action of the dying bait fish lure 300 by initiating retrieval of the fishing line 114 across the water. The dying bait fish lure 300, while referred to as simulating the action of a dying minnow, is also configured to simulate various distressed fish actions in water. During the initial retrieval of the fishing line 114 toward the angler, the angler may sweep the fishing rod sideways and perform jigging movements with the tip of the fishing rod. The sweeping and jigging movements of the fishing rod in the retrieve mode invoke the dying minnow action of the dying bait fish lure 300, where the dying bait fish lure 300 swims in an upward direction during the initial retrieval of the fishing line 114 due to the structure and placement of the lip member 106 and the strategically placed balance weight member 107 in the extended lower body 304 of the lure member 301, and thereafter slowly falls head-first when the angler pauses the retrieval of the fishing line 114. The angler's actions with the fishing rod cause the dying bait fish lure 300 to repeatedly dart and swim in the upward direction, and then fall slowly as though dying many times until death, to lure the target game fish. This dying minnow action of the dying bait fish lure 300 may invoke and cause a predatory and instinctive reaction from the target game fish, which observes the upward movement and downward fall of the dying bait fish lure 300 and bites the bait 401 in the dying bait fish lure 300, thereby getting caught in the hook elements 108 and 109 of the dying bait fish lure 300.

The dying bait fish lure 100/300 disclosed herein provides an improvement over a basic swimming bait fish lure. The dying bait fish lure 100/300 executes a dying bait fish action, for example, a dying minnow action, comprising a straight, upward swim action during retrieval of the fishing line 114 followed by a motionless, slow, downward fall action of the dying bait fish lure 100/300 when the retrieval of the fishing line 114 is paused, as opposed to a mere forward and downward movement executed by conventional fishing lures. The straight, upward, swim action followed by the dead, motionless, slow, downward fall action is the action of a dying bait fish, for example, a dying minnow. The dying bait fish lure 100/300 is configured to swim in an upward direction when the fishing line 114 is retrieved due to the structure and the positioning of the lip member 106 and the strategically positioned balance weight member 107 within the lure member 101/301. When an angler pauses retrieval of the fishing line 114, the dying bait fish lure 100/300 slowly falls head-first with a motionless, slow, downward fall action in the water, thereby simulating the action of a dying bait fish. The slow fall is achieved by the dying bait fish lure 100/300 being close to neutral buoyancy with a slight weight of the weight member 107 applied toward the head 102/302 of the lure member 101/301. The center 107a of the weight member 107 being to the right of the central balance point 113c of the lure member 101/301 illustrated in FIG. 1D and FIG. 3B, toward the head 102/302 of the lure member 101/301, causes the head-first dive of the dying bait fish lure 100/300 when the fishing line 114 is relaxed. In the retrieval mode, the dying bait fish lure 100/300 is configured to repeatedly dart and swim in an upward direction, and then, when the retrieval of the fishing line 114 is paused, fall slowly as though dying many times until death, to lure target game fish. This dying bait fish action of the dying bait fish lure 100/300 invokes and causes a predatory and instinctive reaction from a large, predatory fish. The predatory fish may observe the upward movement and downward fall of the dying bait fish lure 100/300, recognize these erratic actions as that of easy prey, and attack the dying bait fish lure 100/300, thereby getting caught. The dying bait fish action of the dying bait fish lure 100/300 also invokes an instinctive, irresistible response that causes even non-feeding fish to strike the dying bait fish lure 100/300.

The dying bait fish lure 100/300 performs an upward swimming action during an upward pull of the fishing line 114 and comes up straight in line with the fishing line 114. When the tension in the fishing line 114 is released, the dying bait fish lure 100/300 falls naturally due to the structure and position of the weight member 107 within the lure member 101/301. When the fishing line 114 is retrieved, the dying bait fish lure 100/300 performs an upward swimming action that is facilitated by the attached lip member 106. The lip member 106 that is attached at the top of the head 102/302 of the lure member 101/301 causes the dying bait fish lure 100/300 to swim in a straight, upward direction. The lip member 106 imparts action and upward movement. The weight member 107 being positioned at the belly 103a or the extended lower body 304 of the lure member 101/301 maintains the belly 103a or the extended lower body 304 of the lure member 101/301 in a downward position while keeping the lip member 106 facing upward so that the upward facing lip member 106 forces the dying bait fish lure 100/300 to climb straight up during retrieval of the fishing line 114. When the retrieval of the fishing line 114 is stopped or paused, the dying bait fish lure 100/300 falls head-first slowly and naturally. The parts of the dying bait fish lure 100/300, for example, the lip member 106 and the weight member 107, operate in conjunction with the lure member 101/301 to successfully execute the dying bait fish action.

The strategically placed weight member 107 at the location between the center of the body 103/304 of the lure member 101/301 and the head 102/302 of the lure member 101/301, with its horizontal interception along the lower center line of the belly 103a or the extended lower body 304 of the lure 101/301, allows the dying bait fish lure 100/300 to sink in a slow natural manner. A minimal amount of weight added to the body 103/304 of the lure member 101/301 that is near neutral buoyancy allows for the slow fall of the dying bait fish lure 100/300. The strategic placement of the weight member 107 toward the head 102/302 of the lure member 101/301 causes the natural fall of the dying bait fish lure 100/300 to be a head-first drop. The weight member 107 maintains an upright balance of an otherwise unbalanced lure body 103/304. The balance provided by the weight member 107 constantly balances the dying bait fish lure 100/300, enabling a straight movement of the dying bait fish lure 100/300 during the retrieval of the fishing line 114, and maintains the dying bait fish lure 100/300 in a ready position to perform repetitive identical actions, namely, the retrieval, upward swimming action and the sinking falling head-first action, each time the dying bait fish lure 100/300 is put into action during fishing. Without the balance provided by the weight member 107, the retrieval of the fishing line 114 would be random and omnidirectional rather than straight up and controlled. The point of placement of the weight member 107 acts as a pivot where the dying bait fish lure 100/300 pivots in an upward direction when retrieved upon or where the dying bait fish lure 100/300 pivots in a downward direction when slack is given to the fishing line 114 to allow the dying bait fish lure 100/300 to fall.

The dying bait fish lure 100/300 improves upon conventional swimming minnow bait lures by replicating a dying minnow's action during retrieval. The balance provided by the weight member 107 allows for precise control of the dying bait fish lure 100/300, ensuring consistent and alluring movements of the dying bait fish lure 100/300, which provoke predatory reactions from target game fish, including those not actively feeding. The upward swimming and head-first descent of the dying bait fish lure 100/300 are achieved by the lip member 106 and the weight member 107, working in conjunction with the lure member 101/301. The strategic placement of the weight member 107 controls the motion of the dying bait fish lure 100/300 during retrieval and descent.

The foregoing examples and illustrative implementations of various embodiments have been provided merely for explanation and are in no way to be construed as limiting the embodiments disclosed herein. Dimensions of various parts of the dying bait fish lure 100/300 disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

I claim:

1. A dying bait fish lure comprising:
a lure member configured to resemble a bait fish comprising a head, a body, and a tail, wherein the head, the body, and the tail define an interior cavity within the lure member;
a lip member disposed dorsally behind and above the head of the lure member;
a weight member disposed in the interior cavity of the lure member, at a location between a center of the body and the head of the lure member;
one or more hook elements attached to one or more predetermined locations of the lure member; and
an eyelet disposed on a front nose end of the lure member, wherein the eyelet is configured to connect a fishing line to the lure member.

2. The dying bait fish lure of claim 1, wherein the lip member is a curved, generally ovular-shaped member configured in one of a plurality of variable sizes for facilitating a plurality of actions and upward movements of the dying bait fish lure, and wherein the weight member is one of a generally rectangular-shaped member and a generally ovular-shaped member with an extended length for weight distribution within the lure member.

3. The dying bait fish lure of claim 1, wherein the lip member is configured to provide direction to the dying bait fish lure and facilitate a dying bait fish action comprising a straight, upward swim action during retrieval of the fishing line followed by a motionless, slow, downward fall action when the retrieval of the fishing line is paused.

4. The dying bait fish lure of claim 1, wherein a horizontal interception of the location of the weight member is along a lower center line of a belly of the lure member, with a center of the weight member disposed slightly forward of a central balance point of the lure member, toward the head of the lure member, to cause a head-first dive of the dying bait fish lure in water when tension in the fishing line is reduced, and wherein the weight member is configured to maintain the belly of the lure member in a downward position while keeping the lip member facing in an upward direction for a straight, upward swim action of the dying bait fish lure during retrieval of the fishing line.

5. The dying bait fish lure of claim 1, wherein the weight member is configured to maintain an upright balance and execute a motionless, slow, downward fall action of the dying bait fish lure, wherein the motionless, slow, downward fall action is achieved by the dying bait fish lure being close to neutral buoyancy in water with a slight weight of the weight member applied toward the head of the lure member, and wherein the weight member is further configured to pivot the lure member in an upward direction during retrieval of the fishing line and to pivot the lure member in a downward direction when tension in the fishing line is reduced and the retrieval of the fishing line is paused to allow the dying bait fish lure to fall.

6. The dying bait fish lure of claim 1, wherein the one or more predetermined locations for attaching the one or more hook elements to the lure member comprise the tail and a lower mid-section of the body of the lure member.

7. The dying bait fish lure of claim 1, further comprising a split ring connected to the eyelet and configured to connect the fishing line to the lure member.

8. A dying bait fish lure comprising:
a lure member configured to resemble a bait fish comprising a head, a body, and a tail, wherein the head, the body, and the tail define an interior cavity within the lure member;
an eyelet disposed on a front nose end of the lure member, wherein the eyelet is configured to connect a fishing line to the lure member;
a lip member disposed dorsally behind and above the head of the lure member, wherein the lip member is configured to provide direction to the dying bait fish lure and facilitate a dying bait fish action comprising a straight, upward swim action during retrieval of the fishing line followed by a motionless, slow, downward fall action when the retrieval of the fishing line is paused;
a weight member disposed in the interior cavity of the lure member, at a location between a center of the body and the head of the lure member, wherein the weight member is configured to maintain an upright balance and execute the motionless, slow, downward fall action of the dying bait fish lure; and
one or more hook elements attached to one or more predetermined locations of the lure member.

9. The dying bait fish lure of claim 8, wherein the lip member is a curved, generally ovular-shaped member configured in one of a plurality of variable sizes for facilitating a plurality of actions and upward movements of the dying bait fish lure, and wherein the weight member is one of a generally rectangular-shaped member and a generally ovular-shaped member with an extended length for weight distribution within the lure member.

10. The dying bait fish lure of claim 8, wherein a horizontal interception of the location of the weight member is along a lower center line of a belly of the lure member, with a center of the weight member disposed slightly forward of a central balance point of the lure member, toward the head of the lure member, to cause a head-first dive of the dying bait fish lure in water when tension in the fishing line is reduced, and wherein the weight member is configured to maintain the belly of the lure member in a downward position while keeping the lip member facing in an upward direction for the straight, upward swim action of the dying bait fish lure during the retrieval of the fishing line.

11. The dying bait fish lure of claim 8, wherein the motionless, slow, downward fall action is achieved by the dying bait fish lure being close to neutral buoyancy in water with a slight weight of the weight member applied toward the head of the lure member, and wherein the weight member is further configured to pivot the lure member in an upward direction during the retrieval of the fishing line and to pivot the lure member in a downward direction when tension in the fishing line is reduced and the retrieval of the fishing line is paused to allow the dying bait fish lure to fall.

12. The dying bait fish lure of claim 8, wherein the one or more predetermined locations for attaching the one or more hook elements to the lure member comprise the tail and a lower mid-section of the body of the lure member.

13. The dying bait fish lure of claim 8, further comprising a split ring connected to the eyelet and configured to connect the fishing line to the lure member.

14. A dying bait fish lure comprising:
a lure member comprising a head, a partial upper body, and an extended lower body, wherein the head, the partial upper body, and the extended lower body define a partially open cavity configured to accommodate a bait, and wherein the bait is attached to one of the head and the partial upper body of the lure member using a securing element;
an eyelet disposed on a front nose end of the lure member, wherein the eyelet is configured to connect a fishing line to the lure member;
a lip member disposed dorsally behind and above the head of the lure member;
a weight member disposed at a location between a center of the extended lower body and the head of the lure member, wherein a horizontal interception of the location of the weight member is along a center line of the extended lower body of the lure member, with a center of the weight member disposed slightly forward of a central balance point of the lure member, toward the head of the lure member, to cause a head-first dive of the dying bait fish lure in water when tension in the fishing line is reduced, and wherein the weight member is configured to maintain the extended lower body of the lure member in a downward position while keeping the lip member facing in an upward direction for a straight, upward swim action of the dying bait fish lure during retrieval of the fishing line;
a first hook element attached to a mid-section of the extended lower body of the lure member; and
a second hook element attached to a distal end of the lure member.

15. The dying bait fish lure of claim 14, further comprising a flexible line member configured to connect the first hook element to the second hook element, wherein the second hook element is configured to hook the bait to the lure member, thereby allowing the bait to undulate in water.

16. The dying bait fish lure of claim 14, wherein the lip member is a curved, generally ovular-shaped member configured in one of a plurality of variable sizes for facilitating a plurality of actions and upward movements of the dying bait fish lure, and wherein the weight member is one of a generally rectangular-shaped member and a generally ovular-shaped member with an extended length for weight distribution within the lure member.

17. The dying bait fish lure of claim 14, wherein the lip member is configured to provide direction to the dying bait fish lure and facilitate a dying bait fish action comprising the straight, upward swim action during the retrieval of the fishing line followed by a motionless, slow, downward fall action when the retrieval of the fishing line is paused.

18. The dying bait fish lure of claim 14, wherein the weight member is configured to maintain an upright balance and execute a motionless, slow, downward fall action of the dying bait fish lure, wherein the motionless, slow, downward fall action is achieved by the dying bait fish lure being close to neutral buoyancy in water with a slight weight of the weight member applied toward the head of the lure member, and wherein the weight member is further configured to pivot the lure member in an upward direction during retrieval of the fishing line and to pivot the lure member in a downward direction when the tension in the fishing line is reduced and the retrieval of the fishing line is paused to allow the dying bait fish lure to fall.

19. The dying bait fish lure of claim 14, further comprising a split ring connected to the eyelet and configured to connect the fishing line to the lure member.

20. The dying bait fish lure of claim 14, wherein the bait is one of a live bait and an artificial bait, and wherein the securing element is one of a pin, a clip, and a safety pin.
